(19) United States
(12) Patent Application Publication
(10) Pub. No.: US 2025/0173192 A1
(43) Pub. Date: May 29, 2025

(54) METHOD FOR GPU RESOURCE MANAGEMENT USING REINFORCEMENT LEARNING AND APPARATUS USING THE SAME

(71) Applicant: Electronics and Telecommunications Research Institute, Daejeon (KR)

(72) Inventors: Yong-Yeon KIM, Daejeon (KR); Gap-Joo NA, Sejong-si (KR); In-Geol Chun, Daejeon (KR)

(73) Assignee: Electronics and Telecommunications Research Institute, Daejeon (KR)

(21) Appl. No.: 18/732,130

(22) Filed: Jun. 3, 2024

(30) Foreign Application Priority Data
Nov. 27, 2023 (KR) 10-2023-0166527

(51) Int. Cl. G06F 9/50

(52) U.S. Cl. CPC G06F 9/505; G06F 9/5038

(57) ABSTRACT

Disclosed herein are a method for GPU resource management using reinforcement learning and an apparatus for the same. The method performed by the apparatus includes deriving a Multi-Instance GPU (MIG) instance configuration that meets a Service Level Objective (SLO) condition and a request rate assigned to a workload by utilizing a pretrained reinforcement learning model and reorganizing MIG resources of a GPU device to correspond to the workload by transferring the MIG instance configuration to the GPU device.

### CROSS REFERENCE TO RELATED APPLICATION

This application claims the benefit of Korean Patent Application No. 10-2023-0166527, filed Nov. 27, 2023, which is hereby incorporated by reference in its entirety into this application.

### BACKGROUND OF THE INVENTION

### 1. Technical Field

The present disclosure relates generally to technology for Graphics Processing Unit (GPU) resource management using reinforcement learning, and more particularly to technology for spatial resource management of a GPU in a cloud environment.

### 2. Description of the Related Art

The importance of deep-learning services in a cloud environment continues to grow, and with the emergence of advanced deep-learning models such as ChatGPT, the range of demand for deep-learning services is expanding from existing experts to general users. Therefore, in order to stably provide services in response to the increasing demand from various users, it is necessary to dynamically configure cloud resources, especially GPUs, and an optimal resource allocation scheduling strategy for multiple services is required.

In order to dynamically configure GPU resources in the cloud, it is necessary to adjust the amount of GPU resources allocated to each workload, and even in a single GPU, it is necessary to spatially divide and allocate resources. To this end, NVIDIA, which is a representative GPU vendor, provides features such as Multi-Process Service (MPS) and Multi-Instance GPU (MIG), which are functions for spatial partitioning and resource management of GPUs. MPS enables multiple users to spatially share Streaming Multi-Processor (SM) of a GPU so as to allow kernels to be simultaneously executed, thereby enabling efficient utilization of GPU resources. Also, it may ensure Quality of Service (QoS) by limiting the SM usage of each user.

However, MPS allows partitioning of only computing resources and does not support isolation of memory resources. Accordingly, resource interference between processes occurs, which may degrade performance. In contrast, MIG supported by the latest NVIDIA GPU architectures allows a single GPU to be divided into up to 7 independent instances and provides each instance with independent memory, computing resources, and hardware bandwidth, thereby preventing interference between different instances and ensuring consistent performance.

MIG instances are broadly divided into two types: GPU instances and compute instances. The GPU instances are instances that only consider the computing resources of the corresponding GPU. When allocating MIG instances, the MIG instances should be allocated according to preset partitions.

### DOCUMENTS OF RELATED ART

(Patent Document 1) Korean Patent Application Publication No. 10-2021-0085490, published on Jul. 8, 2021 and titled “Machine-learning-based task deployment method for GPU application”.

### SUMMARY OF THE INVENTION

An object of the present disclosure is to allocate a minimum amount of GPU resources while guaranteeing a Service Level Objective (SLO) of a workload using MIG technology, thereby reducing energy consumption of an entire cloud server and cutting cost.

Another object of the present disclosure is to derive the optimal MIG instance configuration by monitoring resource usage patterns of various workloads exhibiting different GPU resource usage patterns by utilizing reinforcement learning.

A further object of the present disclosure is to find the minimum number of MIG instances required for each workload, thereby maximizing the efficiency of GPU resource utilization of a cloud.

In order to accomplish the above objects, a method for GPU resource management using reinforcement learning, performed by an apparatus for GPU resource management, according to the present disclosure includes deriving a Multi-Instance GPU (MIG) instance configuration that meets a Service Level Objective (SLO) condition and a request rate assigned to a workload by utilizing a pretrained reinforcement learning model; and reorganizing MIG resources of a GPU device to correspond to the workload by transferring the MIG instance configuration to the GPU device.

Here, deriving the MIG instance configuration may include setting a maximum batch size that does not violate a latency constraint defined in the SLO condition and measuring the throughput of the workload depending on the maximum batch size.

Here, setting the maximum batch size may comprise setting a batch size that makes the sum of batching latency and inference latency closest to the latency constraint without exceeding the latency constraint as the maximum batch size.

Here, the maximum batch size may be calculated by performing curve fitting on latency data of a specific batch size for each instance of the MIG instance configuration.

Here, the method may further include performing, by the apparatus, evaluation about whether the MIG instance configuration is a configuration that allocates a minimum amount of the MIG resources while meeting the SLO condition and the request rate.

Here, performing the evaluation may include calculating a rest request rate by subtracting the throughput from the request rate and applying a weight to the reinforcement learning model in consideration of how far an evaluation value acquired by applying a Gaussian distribution to the reset request rate is away from 0, which is a reference point.

Here, applying the weight may comprise applying the weight to add MIG resources by the MIG instance configuration when the evaluation value is a positive number; and applying the weight to reduce MIG resources by the MIG instance configuration when the evaluation value is a negative number.

Here, the method may further include measuring, by the apparatus, attributes of each workload and inputting the same to state fields; and transferring, by the apparatus, the state fields to a policy network and training, by the apparatus, the reinforcement learning model such that the evaluation value comes close to the reference point.

Here, the attributes of each workload may include the resource usage pattern of the workload and throughput and latency depending on the MIG instance size and batch size of the workload.

Here, the resource usage pattern of each workload may include GPU utilization data and Streaming Multi-Processor (SM) occupancy data.

Here, the apparatus may run in a backend process of a cloud environment.

Also, an apparatus for GPU resource management according to an embodiment of the present disclosure includes a reinforcement learning scheduler module for deriving a Multi-Instance GPU (MIG) instance configuration that meets a Service Level Objective (SLO) condition and a request rate assigned to a workload by utilizing a pretrained reinforcement learning model and an MIG allocation module for transferring the MIG instance configuration to a GPU device. The GPU device reorganizes MIG resources to correspond to the workload.

Here, the reinforcement learning scheduler module may set a maximum batch size that does not violate a latency constraint defined in the SLO condition, and the apparatus for GPU resource management may further include a runtime profiler module for measuring the throughput of the workload depending on the maximum batch size.

Here, the reinforcement learning scheduler module may set a batch size that makes the sum of batching latency and inference latency closest to the latency constraint without exceeding the latency constraint as the maximum batch size.

Here, the reinforcement learning scheduler module may calculate the maximum batch size by performing curve fitting on latency data of a specific batch size for each instance of the MIG instance configuration.

Here, the reinforcement learning scheduler module may perform evaluation about whether the MIG instance configuration is a configuration that allocates a minimum amount of the MIG resources while meeting the SLO condition and the request rate.

Here, the reinforcement learning scheduler module may calculate a rest request rate by subtracting the throughput from the request rate and apply a weight to the reinforcement learning model in consideration of how far an evaluation value acquired by applying a Gaussian distribution to the reset request rate is away from 0, which is a reference point.

Here, when the evaluation value is a positive number, the reinforcement learning scheduler module may apply the weight to add MIG resources by the MIG instance configuration, whereas when the evaluation value is a negative number, the reinforcement learning scheduler module may apply the weight to reduce MIG resources by the MIG instance configuration.

Here, the reinforcement learning scheduler module may measure attributes of each workload, input the same to state fields, transfer the state fields to a policy network, and train the reinforcement learning model such that the evaluation value comes close to the reference point.

Here, the attributes of each workload may include the resource usage pattern of the workload and throughput and latency depending on the MIG instance size and batch size of the workload.

Here, the resource usage pattern of each workload may include GPU utilization data and Streaming Multi-Processor (SM) occupancy data.

Here, the apparatus for GPU resource management may run in a backend process of a cloud environment.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a flowchart illustrating a method for GPU resource management using reinforcement learning according to an embodiment of the present disclosure;

FIG. 2 is a view illustrating an example of the structure of a system for efficient space management of GPU resources according to the present disclosure;

FIG. 3 is a view illustrating an example of a detailed structure of a reinforcement learning scheduler according to the present disclosure;

FIG. 4 is a view illustrating an example of the number of cases of all MIG instance configurations (allowed in NVIDIA A100) according to the present disclosure;

FIG. 5 is a flowchart illustrating in detail a process of training a reinforcement learning model in a GPU resource management process according to an embodiment of the present disclosure;

FIG. 6 is a flowchart illustrating in detail a process of deriving an MIG instance configuration in a GPU resource management process according to an embodiment of the present disclosure;

FIG. 7 is a flowchart illustrating in detail a process of evaluating and updating the function of a reinforcement learning model in a GPU resource management process according to an embodiment of the present disclosure; and

FIG. 8 is a view illustrating an apparatus for GPU resource management using reinforcement learning according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

When multiple users share the same GPU resource in a cloud environment, it is very challenging to consistently meet a real-time Service-Level Objective (SLO) for the task of each of the users. The SLO defines quality of service and is a temporal threshold value that must be met at a specific request rate from a user. A service provider is required to accurately predict the expected resource usage in order to guarantee the SLO of each deep-learning inference workload. It is necessary to allocate a suitable amount of resources based on such prediction, to quickly respond to a change in a dynamic environment, and to thereby continuously provide the optimal service to users.

There are existing studies and inventions for allocating the optimal resources to a deep-learning inference workload using GPU spatial partitioning techniques. In the studies exploiting Multi-Process Service (MPS), the optimal resource amount is predicted by approximating performance interference between workloads running on the same GPU and reflecting the same to target latency. However, this is not an actually measured value, so a different result may be obtained in the actual environment. Meanwhile, the studies exploiting Multi-Instance GPU (MIG) are not affected by interference, but do not involve content about a change in the amount of required resources varying depending on a change in the SLO of a client, so it is difficult to apply this in the actual service environment.

The present disclosure proposes a method for reducing energy consumption of an entire cloud server and cutting cost by using a smaller number of GPUs than existing technologies by allocating a minimum amount of GPU resources while guaranteeing the SLOs of workloads using MIG technology depending on the varying SLOs from various clients.

Because it is difficult to predict accurate resource usage for all deep-learning inference workloads, reinforcement learning is used to perform pretraining using various workloads exhibiting different GPU resource usage patterns in the present disclosure. Accordingly, when a new type of workload is input, the resource usage pattern of the corresponding workload is monitored, whereby the optimal MIG instance configuration may be derived. Consequently, the minimum number of MIG instances required for each workload can be found, whereby the efficiency of GPU resource utilization of the cloud may be maximized.

Hereinafter, a preferred embodiment of the present disclosure will be described in detail with reference to the accompanying drawings.

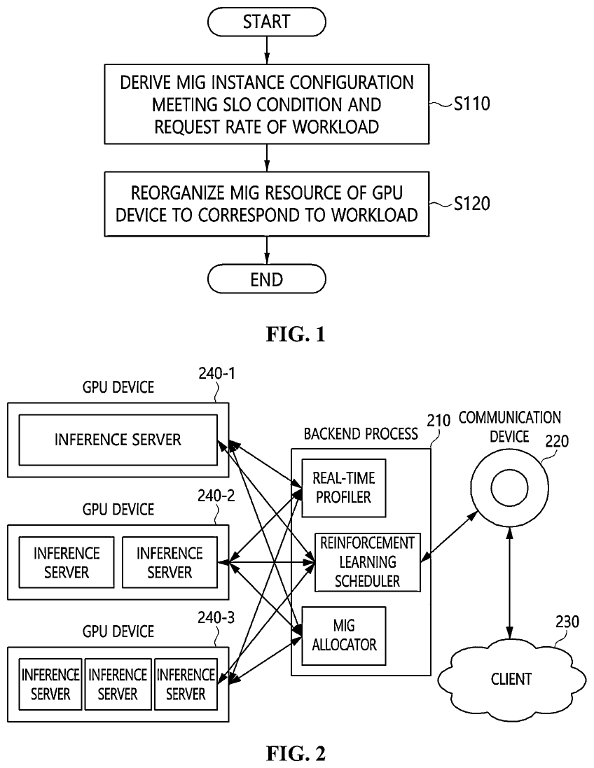

FIG. 1 is a flowchart illustrating a method for GPU resource management using reinforcement learning according to an embodiment of the present disclosure.

Referring to FIG. 1, in the method for GPU resource management using reinforcement learning according to an embodiment of the present disclosure, a GPU resource management apparatus derives a Multi-Instance GPU (MIG) instance configuration that meets a Service Level Objective (SLO) condition and a request rate assigned to a workload by utilizing a pretrained reinforcement learning model at step S110.

Here, the GPU resource management apparatus may run in the backend process of a cloud environment.

For example, referring to FIG. 2, when a workload is executed in a client 230, execution information may be transferred to the GPU resource management apparatus 210 running in the backend process. The GPU resource management apparatus 210 running in the backend process may analyze the attributes of the corresponding workload using a real-time profiler. A reinforcement learning scheduler may be executed based on the analyzed information.

Here, the maximum batch size that does not violate a latency constraint defined in the SLO condition may be set, and the throughput of the workload depending on the maximum batch size may be measured.

Here, a batch size that makes the sum of batching latency and inference latency closest to the latency constraint without exceeding the latency constraint may be set as the maximum batch size.

Here, curve fitting is performed on the latency data of a specific batch size for each instance of the MIG instance configuration, whereby the maximum batch size may be calculated.

For example, referring to FIG. 2, the overall structure of the present disclosure may have a form of a centralized server. Here, in order to enable multiple clients to access a network without much latency, a request from each client 230 may be received through an asynchronous communication device 220 in the present disclosure. In response to the requirement of the client 230, the reinforcement learning scheduler determines the MIG partition to be used in each of GPU devices 240-1 to 240-3 and the batch size of a target model.

Also, in the method for GPU resource management using reinforcement learning according to an embodiment of the present disclosure, the GPU resource management apparatus transfers the MIG instance configuration to the GPU devices and reorganizes the Multi-Instance GPU (MIG) resources of the GPU devices to correspond to the workload at step S120.

For example, referring to FIG. 2, the reinforcement learning scheduler in the GPU resource management apparatus 210 running in the backend process sends the new MIG configuration information to an MIG allocator, thereby reorganizing the resources of the GPU devices 240-1 to 240-3.

That is, depending on the MIG partition determined by the reinforcement learning scheduler, the MIG allocator in the GPU resource management apparatus 210 may configure the deployment of the MIG instances of the GPU devices 240-1 to 240-3, and deep-learning inference servers may operate in the corresponding MIG instances.

Also, although not illustrated in FIG. 1, in the method for GPU resource management using reinforcement learning according to an embodiment of the present disclosure, the GPU resource management apparatus performs evaluation about whether the MIG instance configuration is a configuration that allocates a minimum amount of MIG resources while meeting the SLO condition and the request rate.

Here, a rest request rate is calculated by subtracting throughput from the request rate, and a weight may be applied to the reinforcement learning model in consideration of how far an evaluation value acquired by applying a Gaussian distribution to the rest request rate is away from 0, which is a reference point.

Here, when the evaluation value is a positive number, the weight may be applied to add MIG resources by the MIG instance configuration, whereas when the evaluation value is a negative number, the weight may be applied to reduce MIG resources by the MIG instance configuration.

For example, referring to FIG. 2, while the inference servers are operating on the GPU devices 240-1 to 240-3, the real-time profiler in the GPU resource management apparatus 210 performs real-time monitoring for each MIG instance, thereby measuring a value to be used for calculation for checking whether the allocated instance is suitable. Finally, the answer derived by the deep-learning inference server is sent back to the client 230, and the reinforcement learning scheduler may be retrained based thereon.

Also, although not illustrated in FIG. 1, in the method for GPU resource management using reinforcement learning according to an embodiment of the present disclosure, the GPU resource management apparatus measures the attributes of each workload, inputs the same to state fields, and transfers the state fields to a policy network, thereby training the reinforcement learning model such that the evaluation value comes close to the reference point.

Here, the attributes of each workload may include the resource usage pattern of the workload and throughput and latency depending on the MIG instance size and batch size of the workload.

Here, the resource usage pattern of each workload may include GPU utilization data and Streaming Multi-Processor (SM) occupancy data.

Through the above-described method for GPU resource management, energy consumption of an entire cloud server and cost may be reduced by allocating a minimum amount of GPU resources while guaranteeing the SLO of a workload using MIG technology.

Also, the optimal MIG instance configuration may be derived by monitoring the resource usage patterns of various workloads exhibiting different GPU resource usage patterns using reinforcement learning.

Also, the minimum number of MIG instances required for each workload is found, whereby the efficiency of GPU resource utilization of a cloud may be maximized.

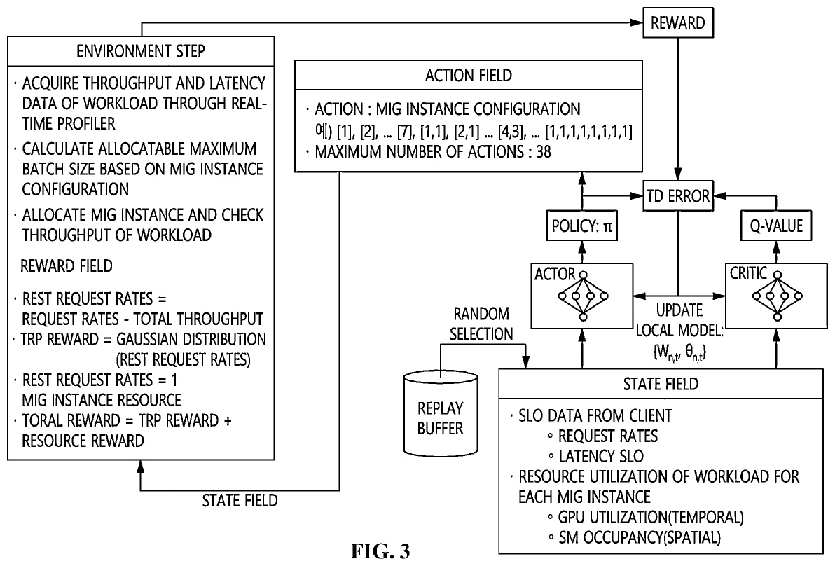

FIG. 3 is a view illustrating an example of a detailed structure of a reinforcement learning scheduler according to the present disclosure.

Referring to FIG. 3, the state fields of the reinforcement learning scheduler according to the present disclosure include SLO data received from a client and the resource utilization of a workload in each MIG instance.

At the environment step of the reinforcement learning scheduler, throughput and latency data of a workload are acquired using a real-time profiler, and an allocatable maximum batch size may be calculated based on an MIG instance configuration. Subsequently, an MIG instance is allocated, and the throughput of the workload may be checked.

In the action field of the reinforcement learning scheduler, MIG instance configuration information may be derived.

Here, reinforcement learning corresponds to a branch of machine learning that performs training in order for an agent to discover an action strategy for maximizing a reward through the interaction with an environment. The agent is an entity that makes a decision and selects an action based on given information. The environment reacts to the action of the agent and provides a change in the state and a reward as the result thereof. The state indicates the current condition of the environment, and the reward corresponds to a criterion for evaluating how good the action of the agent is. The actor-critic method, which forms the basis of various current reinforcement learning models, is configured with a policy network trained to increase a reward and a value network for approximating a value function for various states, and may be used as the core algorithm of the reinforcement learning scheduler according to an embodiment of the present disclosure.

Here, the reinforcement learning scheduler may be broadly into two steps: a training step and a runtime step.

First, at the training step, a reinforcement learning model is trained. Here, real-time profiling is performed depending on the type of a workload, whereby the resource usage pattern of the model and throughput and latency depending on an MIG instance size and a batch size may be measured and used as data to be used for training.

The runtime step is a step for an actual service, and is applied to the trained reinforcement learning model depending on the GPU resource usage pattern monitored in real time in the state in which prior information about a requested workload is not known, whereby the optimal MIG instance configuration may be derived.

Subsequently, the reinforcement learning scheduler may generate state fields from the SLO data for the workload and resource usage data through observation and transfer the same to the policy network of the reinforcement learning model. Here, the state fields may be configured with the SLO condition assigned to the current workload, that is, the latency constraint of the SLO that should be observed over time, and the request rate that should be satisfied through this step. Also, GPU utilization data and SM occupancy data, which represent the resource usage characteristics of the corresponding workload, may be brought from the real-time profiling data and incorporated in the state fields.

Accordingly, when the reinforcement learning model is applied to the runtime step after training is finished, the resource usage pattern may be measured through monitoring even if the deep-learning model corresponding to the workload is unknown. Also, the optimal action may be determined in the policy network by determining a similar deep-learning model in connection with the attributes of the workloads learned at the training step.

Also, at the runtime step, the maximum batch size that does not violate the latency constraint defined in the SLO is set according to the action determined in the policy network, and throughput depending on the maximum batch size may be measured. Here, the action field of the reinforcement learning scheduler may indicate the number of all possible MIG instance configurations that enable execution of the workload.

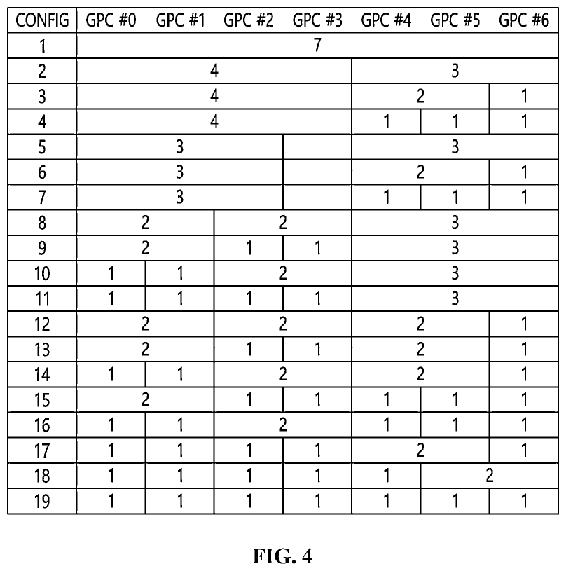

For example, FIG. 4 illustrates the number of cases for all MIG instances configurations allowed in NVIDIA A100 GPUs.

Among the instance locations 0 to 6 (GPC #0 to GPC #6) illustrated in FIG. 4, the instance location 0 (GPC #0) may be allocated an instance with one, two, three, four, or seven GPU slices, but the instance location 2 (GPC #2) may be allocated only an instance with one GPU slice or two GPU slices.

Also, assuming that only one MIG instance is generated, a total of five MIG instance configurations is possible, and the possible five MIG instance configurations may be {1}, {2}, {3}, {4}, and {7}. Assuming that two MIG instances are generated, a total of nine MIG configurations are possible, and the possible nine MIG configurations may be {1,1}, {2,1}, {2,2}, {2,3}, {3,1}, {3,3}, {4,1}, {4,2}, and {4,3}. However, the total amount of instance resources generated in the MIG instance configuration cannot exceed a 7-instance size. For example, the configuration such as {4, 4} is not possible because the total of instances is 8. The number of actions of the action field that can be configured in this way may be 38.

Here, when one action is determined in the policy network of the reinforcement learning scheduler, the maximum batch size of a workload may be set based thereon. Here, batching latency corresponds to a value acquired by dividing a specific batch size by a request rate, and inference latency corresponds to the time taken to perform inference once with the specific batch size. Here, the batch size that makes the sum of the batching latency and the inference latency closest to the latency constraint defined in the SLO without exceeding the latency constraint may correspond to the maximum batch size. Also, the maximum batch size may be calculated by performing curve fitting on the latency data of a specific batch size measured by the real-time profiler for each instance of the MIG instance configuration, and throughput based thereon may be calculated by measuring the same in real time through the real-time profiler. The throughput data calculated as described above may be used to calculate a reward of the reinforcement learning model.

Here, the reinforcement learning scheduler may evaluate whether the MIG instance configuration set through the action of the action field is a configuration having a minimum amount of MIG resources meeting the SLO.

Here, the reward for the evaluation may be divided into two parts.

The first one is a Gaussian distribution. A rest request rate, which corresponds to a value acquired by subtracting throughput from the request rate, is calculated, a Gaussian distribution is applied to the rest request rate, and how far the resultant value is away from 0, which is a reference point, is determined, whereby a weight may be applied. When the calculated rest request rate is a positive number, this indicates that the current configuration does not satisfy the request rate, and it may be necessary to additionally allocate MIG instances. Conversely, when the calculated rest request rate is a negative number, this indicates that throughput is greater than the required request rate in the current configuration, and reconfiguration may be made such that a minimum amount of MIG resources is to be allocated.

The second one is an 1/MIG instance resource, and a large MIG instance resource indicates that more MIG resources are allocated to a workload in order to satisfy a request rate, so a weight may be set to provide a smaller reward.

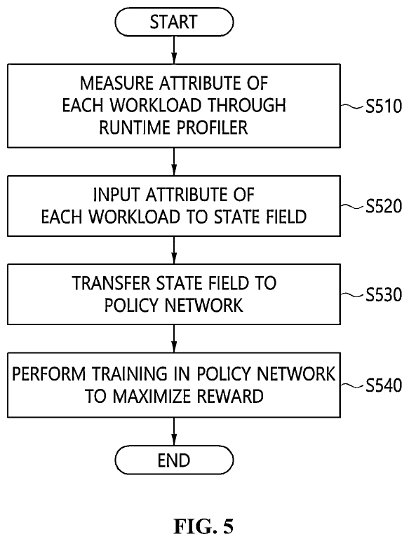

FIG. 5 is a flowchart illustrating in detail a process of training a reinforcement learning model in a GPU resource management process according to an embodiment of the present disclosure.

Referring to FIG. 5, in the process of training a reinforcement learning model in the GPU resource management process according to an embodiment of the present disclosure, attributes of each workload are measured using a runtime profiler at step S510, and the measured attributes of the workload are input to state fields at step S520.

Here, the attributes of each workload may include the resource usage pattern of the workload and throughput and latency depending on the MIG instance size and batch size of the workload.

Here, the resource usage pattern of each workload may include GPU utilization data and Streaming Multi-Processor (SM) occupancy data.

Subsequently, the state fields are transferred to a policy network at step S530, and training is performed to maximize a reward at step S540.

For example, a rest request rate is calculated by subtracting throughput from a request rate, and a reinforcement learning model may be trained such that an evaluation value acquired by applying a Gaussian distribution to the rest request rate comes close to a reference point.

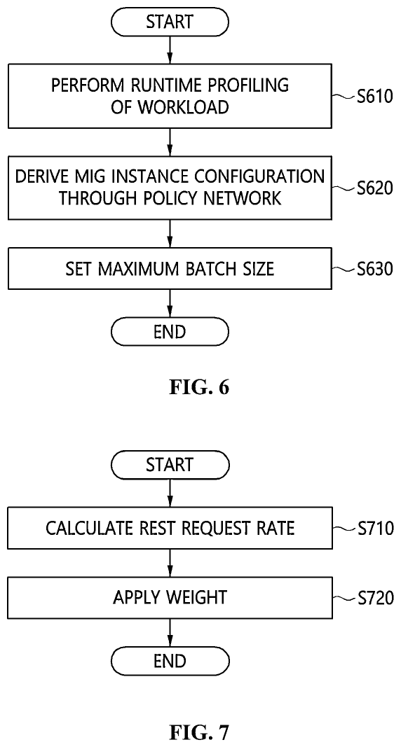

FIG. 6 is a flowchart illustrating in detail a process of deriving an MIG instance configuration in a GPU resource management process according to an embodiment of the present disclosure.

Referring to FIG. 6, in the process of deriving an MIG instance configuration in the GPU resource management process according to an embodiment of the present disclosure, first, profiling of a workload is performed using a real-time profiler at step S610.

Subsequently, an MIG instance configuration is derived through a policy network at step S620, and a maximum batch size that does not violate a latency constraint defined in an SLO condition is set at step S630.

Here, curve fitting is performed on the latency data of a specific batch size for each instance of the MIG instance configuration, whereby the maximum batch size may be calculated.

Here, a batch size that makes the sum of batching latency and inference latency closest to the latency constraint without exceeding the latency constraint may be set as the maximum batch size.

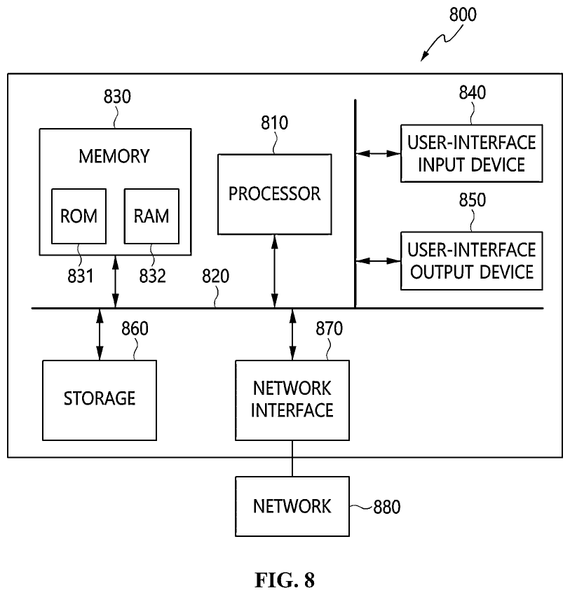

FIG. 7 is a flowchart illustrating in detail a process of evaluating and updating the function of a reinforcement learning model in a GPU resource management process according to an embodiment of the present disclosure.

Referring to FIG. 7, in the process of evaluating and updating the function of a reinforcement learning model in the GPU resource management process according to an embodiment of the present disclosure, first, a rest request rate is calculated by subtracting throughput from a request rate at step S710.

Subsequently, a weight is applied to the reinforcement learning model at step S720 in consideration of how far an evaluation value acquired by applying a Gaussian distribution to the rest request rate is away from 0, which is a reference point.

Here, when the evaluation value is a positive number, the weight may be applied to add MIG resources by the MIG instance configuration, whereas when the evaluation value is a negative number, the weight may be applied to reduce MIG resources by the MIG instance configuration.

FIG. 8 is a view illustrating an apparatus for GPU resource management using reinforcement learning according to an embodiment of the present disclosure.

Referring to FIG. 8, the apparatus for GPU resource management using reinforcement learning according to an embodiment of the present disclosure may be implemented in a computer system including a computer-readable recording medium. As illustrated in FIG. 8, the computer system 800 may include one or more processors 810, memory 830, a user-interface input device 840, a user-interface output device 850, and storage 860, which communicate with each other via a bus 820. Also, the computer system 800 may further include a network interface 870 connected to a network 880. The processor 810 may be a central processing unit or a semiconductor device for executing processing instructions stored in the memory 830 or the storage 860. The memory 830 and the storage 860 may be any of various types of volatile or nonvolatile storage media. For example, the memory may include ROM 831 or RAM 832.

Accordingly, an embodiment of the present disclosure may be implemented as a non-transitory computer-readable medium in which methods implemented using a computer or instructions executable in a computer are recorded. When the computer-readable instructions are executed by a processor, the computer-readable instructions may perform a method according to at least one aspect of the present disclosure.

Here, the processor 810 illustrated in FIG. 8 may correspond to a module taking a role of the real-time profiler, the reinforcement learning scheduler, and the MIG allocator illustrated in FIG. 2.

The processor 810 derives a Multi-Instance GPU (MIG) instance configuration meeting a Service Level Objective (SLO) condition and a request rate assigned to a workload by utilizing a pretrained reinforcement learning model.

Here, the GPU resource management apparatus may run in the backend process of a cloud environment.

For example, referring to FIG. 2, when a workload is executed in a client 230, execution information may be transferred to the GPU resource management apparatus 210 running in the backend process. The GPU resource management apparatus 210 running in the backend process may analyze the attributes of the corresponding workload using the real-time profiler. Based on the analyzed information, the reinforcement learning scheduler may be executed.

Here, a maximum batch size that does not violate a latency constraint defined in the SLO condition may be set, and the throughput of the workload depending on the maximum batch size may be measured.

Here, a batch size that makes the sum of batching latency and inference latency closest to the latency constraint without exceeding the latency constraint may be set as the maximum batch size.

Here, curve fitting is performed on the latency data of a specific batch size for each instance of the MIG instance configuration, whereby the maximum batch size may be calculated.

For example, referring to FIG. 2, the overall structure of the present disclosure may have a form of a centralized server. Here, in order to enable multiple clients to access a network without much latency, a request from each client 230 may be received through an asynchronous communication device 220 in the present disclosure. In response to the requirement of the client 230, the reinforcement learning scheduler determines the MIG partition to be used in each of GPU devices 240-1 to 240-3 and the batch size of a target model.

Also, the processor 810 transfers the MIG instance configuration to the GPU devices and reorganizes the Multi-Instance GPU (MIG) resources of the GPU devices to correspond to the workload.

For example, referring to FIG. 2, the reinforcement learning scheduler in the GPU resource management apparatus 210 running in the backend process sends the new MIG configuration information to the MIG allocator, thereby reorganizing the resources of the GPU devices 240-1 to 240-3.

That is, depending on the MIG partition determined by the reinforcement learning scheduler, the MIG allocator in the GPU resource management apparatus 210 may configure the deployment of the MIG instances of the GPU devices 240-1 to 240-3, and deep-learning inference servers may operate in the corresponding MIG instances.

Also, the processor 810 performs evaluation about whether the MIG instance configuration is a configuration that allocates a minimum amount of MIG resources while meeting the SLO condition and the request rate.

Here, a rest request rate is calculated by subtracting throughput from the request rate, and a weight may be applied to the reinforcement learning model in consideration of how far an evaluation value acquired by applying a Gaussian distribution to the rest request rate is away from 0 that is a reference point.

Here, when the evaluation value is a positive number, the weight may be applied to add MIG resources by the MIG instance configuration, whereas when the evaluation value is a negative number, the weight may be applied to reduce MIG resources by the MIG instance configuration.

For example, referring to FIG. 2, while the inference servers are operating on the GPU devices 240-1 to 240-3, the real-time profiler in the GPU resource management apparatus 210 performs real-time monitoring for each MIG instance, thereby measuring a value to be used for calculation for checking whether the allocated instance is suitable. Finally, the answer derived by the deep-learning inference server is sent back to the client 230, and the reinforcement learning scheduler may be retrained based thereon.

Also, the processor 810 measures the attributes of each workload, inputs the same to state fields, and transfers the state fields to the policy network, thereby training the reinforcement learning model such that the evaluation value comes close to the reference point.

Here, the attributes of each workload may include the resource usage pattern of each workload and throughput and latency depending on the MIG instance size and batch size of the workload.

Here, the resource usage pattern of each workload may include GPU utilization data and Streaming Multi-Processor (SM) occupancy data.

By the above-described GPU resource management apparatus, the SLO of a workload is guaranteed using MIG technology in response to varying SLOs from various clients, and minimum amounts of GPU resources are allocated so as to use a smaller number of GPUs than conventional technology, whereby energy consumption of an entire cloud server and cost may be reduced.

Also, because it is difficult to predict accurate resource usage for all deep-learning inference workloads, pretraining may be performed using various workloads exhibiting different GPU resource usage patterns by utilizing reinforcement learning.

Accordingly, when a new type of workload is input later, the resource usage pattern of the corresponding workload is monitored, whereby the optimal MIG instance configuration may be derived.

Consequently, the minimum number of MIG instances required for each workload may be found, whereby the efficiency of GPU resource utilization of the cloud may be maximized.

According to the present disclosure, energy consumption of an entire cloud server and cost may be reduced by allocating a minimum amount of GPU resources while guaranteeing an SLO of a workload using MIG technology.

Also, the present disclosure may derive the optimal MIG instance configuration by monitoring resource usage patterns of various workloads exhibiting different GPU resource usage patterns using reinforcement learning.

Also, the present disclosure finds the minimum number of MIG instances required for each workload, thereby maximizing the efficiency of GPU resource utilization of a cloud.

As described above, the method for GPU resource management using reinforcement learning and the apparatus for the same according to the present disclosure are not limitedly applied to the configurations and operations of the above-described embodiments, but all or some of the embodiments may be selectively combined and configured, so the embodiments may be modified in various ways.

What is claimed is:

1. A method for Graphics Processing Unit (GPU) resource management using reinforcement learning, performed by an apparatus for GPU resource management, comprising:
deriving a Multi-Instance GPU (MIG) instance configuration that meets a Service Level Objective (SLO) condition and a request rate assigned to a workload by utilizing a pretrained reinforcement learning model; and
reorganizing MIG resources of a GPU device to correspond to the workload by transferring the MIG instance configuration to the GPU device.

2. The method of claim 1, wherein deriving the MIG instance configuration includes
setting a maximum batch size that does not violate a latency constraint defined in the SLO condition; and
measuring throughput of the workload depending on the maximum batch size.

3. The method of claim 2, wherein setting the maximum batch size comprises setting a batch size that makes a sum of batching latency and inference latency closest to the latency constraint without exceeding the latency constraint as the maximum batch size.

4. The method of claim 2, wherein the maximum batch size is calculated by performing curve fitting on latency data of a specific batch size for each instance of the MIG instance configuration.

5. The method of claim 2, further comprising:
performing, by the apparatus, evaluation about whether the MIG instance configuration is a configuration that allocates a minimum amount of the MIG resources while meeting the SLO condition and the request rate.

6. The method of claim 5, wherein performing the evaluation includes
calculating a rest request rate by subtracting the throughput from the request rate; and
applying a weight to the reinforcement learning model in consideration of how far an evaluation value acquired by applying a Gaussian distribution to the reset request rate is away from 0, which is a reference point.

7. The method of claim 6, wherein applying the weight comprises applying the weight to add MIG resources by the MIG instance configuration when the evaluation value is a positive number; and applying the weight to reduce MIG resources by the MIG instance configuration when the evaluation value is a negative number.

8. The method of claim 6, further comprising:
measuring, by the apparatus, attributes of each workload and inputting, by the apparatus, the attributes to state fields; and
transferring, by the apparatus, the state fields to a policy network and training, by the apparatus, the reinforcement learning model such that the evaluation value comes close to the reference point.

9. The method of claim 8, wherein the attributes of each workload include a resource usage pattern of the workload and throughput and latency depending on an MIG instance size and batch size of the workload.

10. The method of claim 9, wherein the resource usage pattern of each workload includes GPU utilization data and Streaming Multi-Processor (SM) occupancy data.

11. The method of claim 1, wherein the apparatus runs in a backend process of a cloud environment.

12. An apparatus for Graphics Processing Unit (GPU) resource management, comprising:
a reinforcement learning scheduler module for deriving a Multi-Instance GPU (MIG) instance configuration that meets a Service Level Objective (SLO) condition and a request rate assigned to a workload by utilizing a pretrained reinforcement learning model; and
an MIG allocation module for transferring the MIG instance configuration to a GPU device,
wherein:
the GPU device reorganizes MIG resources to correspond to the workload.

13. The apparatus of claim 12, wherein the reinforcement learning scheduler module sets a maximum batch size that does not violate a latency constraint defined in the SLO condition,
the apparatus further comprising:
a runtime profiler module for measuring throughput of the workload depending on the maximum batch size.

14. The apparatus of claim 13, wherein the reinforcement learning scheduler module sets a batch size that makes a sum of batching latency and inference latency closest to the latency constraint without exceeding the latency constraint as the maximum batch size.

15. The apparatus of claim 13, wherein the reinforcement learning scheduler module calculates the maximum batch size by performing curve fitting on latency data of a specific batch size for each instance of the MIG instance configuration.

16. The apparatus of claim 13, wherein the reinforcement learning scheduler module performs evaluation about whether the MIG instance configuration is a configuration that allocates a minimum amount of the MIG resources while meeting the SLO condition and the request rate.

17. The apparatus of claim 16, wherein the reinforcement learning scheduler module calculates a rest request rate by subtracting the throughput from the request rate and applies a weight to the reinforcement learning model in consideration of how far an evaluation value acquired by applying a Gaussian distribution to the reset request rate is away from 0, which is a reference point.

18. The apparatus of claim 17, wherein, when the evaluation value is a positive number, the reinforcement learning scheduler module applies the weight to add MIG resources by the MIG instance configuration, whereas when the evaluation value is a negative number, the reinforcement learning scheduler module applies the weight to reduce MIG resources by the MIG instance configuration.

19. The apparatus of claim 17, wherein the reinforcement learning scheduler module measures attributes of each workload, inputs the attributes to state fields, transfers the state fields to a policy network, and trains the reinforcement learning model such that the evaluation value comes close to the reference point.

20. The apparatus of claim 19, wherein the attributes of each workload include a resource usage pattern of the workload and throughput and latency depending on an MIG instance size and batch size of the workload.
